(19) United States
(12) Patent Application Publication
(10) Pub. No.: US 2024/0347711 A1
(43) Pub. Date: Oct. 17, 2024

(54) POSITIVE ELECTRODE COMPOSITE MATERIAL, PREPARATION METHOD THEREFOR, POSITIVE ELECTRODE AND LITHIUM ION SECONDARY BATTERY

(71) Applicant: MURATA MANUFACTURING CO., LTD., Kyoto (JP)

(72) Inventors: Yuli LI, Shanghai (CN); Siming YANG, Shanghai (CN); Jixian LV, Shanghai (CN)

(21) Appl. No.: 18/756,030

(22) Filed: Jun. 27, 2024

Related U.S. Application Data
(63) Continuation of application No. PCT/CN2022/124191, filed on Oct. 9, 2022.

(30) Foreign Application Priority Data
Jan. 13, 2022 (CN) 2022100363870

(51) Int. Cl. H01M 4/36; C09D 105/00; C09D 105/04; C09D 129/04; H01M 4/02; H01M 4/131; H01M 4/137; H01M 4/525; H01M 4/60; H01M 10/0525

(52) U.S. Cl. CPC H01M 4/366; C09D 105/00; C09D 105/04; C09D 129/04; H01M 4/131; H01M 4/137; H01M 4/525; H01M 4/608; H01M 10/0525; H01M 2004/021; H01M 2004/028

(57) ABSTRACT

A positive electrode composite material, a preparation method therefor, a positive electrode and a lithium ion secondary battery are provided. The positive electrode composite material includes: a positive electrode active material; and a coating layer coating the positive electrode active material, the coating layer includes one or more of a polysaccharide organic polymer, polyvinyl alcohol and polypropylene alcohol. The positive electrode composite material, the method for preparing the positive electrode composite material, and the positive electrode and the lithium ion secondary battery which includes the positive electrode composite material in the present application, can effectively inhibit side reactions between the positive electrode active material and an electrolyte in the lithium ion secondary battery, reduce the dissolution of transition metals in the positive electrode active material, prevent breaking of the positive electrode active material particles, and improve the initial Coulombic efficiency and cycle performance of the lithium ion secondary battery.

### CROSS REFERENCE TO RELATED APPLICATIONS

The present application is a continuation of PCT patent application no. PCT/CN2022/124191, filed on Oct. 9, 2022, which claims priority to Chinese patent application no. 202210036387.0, filed on Jan. 13, 2022, the entire contents of which are incorporated herein by reference.

### BACKGROUND

The present application relates to the field of lithium ion secondary batteries, and in particular, to a positive electrode composite material, a method for preparing the positive electrode composite material, and a positive electrode and a lithium ion secondary battery which include the positive electrode composite material.

In recent years, along with the continuous development of electronic technology, demand of people for a battery apparatus supporting energy supply of an electronic device is also increasing continuously. Today, batteries capable of storing more electric quantity and capable of outputting high power are needed. Conventional lead-acid batteries and nickel-hydrogen batteries and the like have been unable to meet the requirements of new electronic products such as mobile devices such as smart phones and fixed devices such as electric power storage systems and the like. Therefore, lithium ion secondary batteries have attracted people's wide attention. In the development of lithium ion secondary batteries, the capacity and performance thereof have been improved effectively.

The lithium ion secondary battery includes a positive electrode including a positive electrode active material, a negative electrode, and an electrolyte. In a charging/discharging process of the lithium ion secondary battery, the electrolyte will dissolve transition metals in the positive electrode active material, resulting in deteriorated cycle performance of the lithium ion secondary battery and unstable electrochemical performance. At present, a general solution is to coat the surface of the positive electrode active material with an inorganic substance such as fluoride, alumina or manganese dioxide. However, due to low conductivity, the effects of these coating methods are not ideal. A method for coating a positive electrode sheet by using metaphosphates and the like is disclosed. However, using this method cannot effectively improve the initial Coulombic efficiency and cycle performance of the lithium ion secondary battery. Therefore, it is necessary to develop a novel positive electrode composite material, a method for preparing the positive electrode composite material, and a positive electrode and a lithium ion secondary battery which includes the positive electrode composite material.

### SUMMARY

The present application, in an embodiment, relates to providing a positive electrode composite material, a method for preparing the positive electrode composite material, and a positive electrode and a lithium ion secondary battery which includes the positive electrode composite material, to solve the problem that it is difficult to effectively improve the initial Coulombic efficiency and cycle performance of a lithium ion secondary battery.

According to one aspect of the present application, provided is a positive electrode composite material, the positive electrode composite material including: a positive electrode active material; and a coating layer coating the positive electrode active material, the coating layer includes one or more of a polysaccharide organic polymer, polyvinyl alcohol and polypropylene alcohol.

Further, the positive electrode active material includes a high-nickel positive electrode material of general formula LiNiₓCo_{y}M_{z}O₂, wherein x+y+z=1, 0.8≤x≤1, 0≤y≤0.2, 0≤z≤0.1, and M is selected from one or more of Mn, Al, Mg, Ti, Fe, Cu, Zn, Ga, Zr, Mo, Nb, W and Si.

Further, in the positive electrode composite material, the polysaccharide organic polymer is selected from one or more of sodium alginate, Arabic gum and guar gum.

Further, based on 100 parts by mass of the positive electrode active material, the amount of the coating layer is in the range of 0.01 parts by mass to 3.5 parts by mass, and preferably, the amount of the coating layer is in the range of 0.01 parts by mass to 2.5 parts by mass.

Further, in the positive electrode composite material, the thickness of the coating layer is in the range of 1 nm to 100 nm.

According to another aspect of the present application, provided is a method for preparing a positive electrode composite material, the method including: a first step: adding water into a coating agent including one or more of a polysaccharide organic polymer, polyvinyl alcohol and polypropylene alcohol to obtain a first mixture, and then stirring the first mixture to obtain a coating solution; and a second step: adding a positive electrode active material into the coating solution to obtain a second mixture, then stirring the second mixture, adding an organic solvent during stirring to obtain a third mixture, performing suction filtration on the third mixture, and drying substances subjected to the suction filtration, to obtain the positive electrode composite material.

According to another aspect of the present application, provided is a method for preparing a positive electrode composite material, the method including: a first step: adding water into a coating agent including one or more of a polysaccharide organic polymer, polyvinyl alcohol and polypropylene alcohol to obtain a first mixture, and then stirring the first mixture to obtain a coating solution; and a second step: adding a positive electrode active material into the coating solution to obtain a second mixture, then placing the second mixture in a water bath and stirring same, and drying remaining substances after water in the second mixture is evaporated, to obtain the positive electrode composite material.

Further, in the method for preparing the positive electrode composite material, in the first step, the stirring speed is in the range of 100-500 rpm and the stirring time is in the range of 1-12 h.

Further, in the method for preparing the positive electrode composite material, in the first step, based on 100 parts by mass of the coating solution, the amount of the coating agent is in the range of 0.01 parts by mass to 3.5 parts by mass, and preferably, the amount of the coating agent is in the range of 0.01 parts by mass to 2.5 parts by mass.

Further, in the method for preparing the positive electrode composite material, in the second step, the stirring speed is in the range of 100-500 rpm.

Further, in the method for preparing the positive electrode composite material, in the second step, based on the total weight of the second mixture, the content of the positive electrode active material in the second mixture is in the range of 4.0 wt %-60 wt %.

Further, in the method for preparing the positive electrode composite material, in the second step, the organic solvent is selected from one of ethanol, isopropanol and ethylene glycol.

Further, in the method for preparing the positive electrode composite material, the addition amount of the organic solvent is 50%-100% of the mass of the coating solution.

Further, in the method for preparing the positive electrode composite material, in the second step, the drying temperature is in the range of 80-120° C., and the drying time is in the range of 4-12 h.

Further, in the method for preparing the positive electrode composite material, in the second step, the temperature of the water bath is in the range of 60-100° C.

Further, in the method for preparing the positive electrode composite material, the positive electrode active material includes a high-nickel positive electrode material of general formula LiNiₓCo_{y}M_{z}O₂, wherein x+y+z=1, 0.8≤x≤1, 0≤y≤0.2, 0≤z≤0.1, and M is selected from one or more of Mn, Al, Mg, Ti, Fe, Cu, Zn, Ga, Zr, Mo, Nb, W and Si.

Further, in the method for preparing the positive electrode composite material, the polysaccharide organic polymer is selected from one or more of sodium alginate, Arabic gum and guar gum.

Further, in the method for preparing the positive electrode composite material, based on 100 parts by mass of the positive electrode active material, the amount of the coating agent is in the range of 0.01 parts by mass to 3.5 parts by mass, and preferably, the amount of the coating agent is in the range of 0.01 parts by mass to 2.5 parts by mass.

According to still another aspect of the present application, provided is a positive electrode of a lithium ion secondary battery, the positive electrode of the lithium ion secondary battery including the positive electrode composite material as described herein.

According to still another aspect of the present application, provided is a lithium ion secondary battery, the lithium ion secondary battery including: a positive electrode, a negative electrode and a separator, the positive electrode including the positive electrode composite material as described herein.

The positive electrode composite material, the method for preparing the positive electrode composite material, and the positive electrode and the lithium ion secondary battery which includes the positive electrode composite material in the present application, can effectively inhibit side reactions between the positive electrode active material and the electrolyte in the lithium ion secondary battery, reduce the dissolution of transition metals in the positive electrode active material, prevent breaking of the positive electrode active material particles, and improve the initial Coulombic efficiency and cycle performance of the lithium ion secondary battery.

### BRIEF DESCRIPTION OF THE FIGURES

FIG. 1 shows a performance of 100 cycles of batteries in Example 2 and Comparative Example 1.

FIG. 2 shows a schematic structural diagram of a positive electrode composite material including a high-nickel positive electrode material.

### DETAILED DESCRIPTION

It is to be noted that examples in the present application and features in the examples may be combined with one another without conflicts. Hereinafter, the present application will be described in further detail including with reference to examples. The following examples are merely exemplary, and are not intended to limit the scope of protection of the present application.

As explained in the Background, it is difficult to effectively improve the initial Coulombic efficiency and cycle performance of a lithium ion secondary battery. In view of such problems, an embodiment of the present application provides a positive electrode composite material, the positive electrode composite material including: a positive electrode active material; and a coating layer coating the positive electrode active material, the coating layer includes one or more of a polysaccharide organic polymer, polyvinyl alcohol and polypropylene alcohol.

In the positive electrode composite material of the present application, the positive electrode active material is coated by the coating layer including one or more of a polysaccharide organic polymer, polyvinyl alcohol and polypropylene alcohol, which can effectively prevent contact between the positive electrode active material and an electrolyte in a lithium ion secondary battery, can effectively inhibit side reactions between the positive electrode active material and the electrolyte in the lithium ion secondary battery, reduce the dissolution of transition metals in the positive electrode active material, prevent breaking of the positive electrode active material particles, and improve the initial Coulombic efficiency and cycle performance of the lithium ion secondary battery.

The positive electrode active material in the present application can use a conventional positive electrode active material. Preferably, in an embodiment of the present application, the positive electrode active material may be a lithium-containing compound. Examples of such a lithium-containing compound includes a lithium-transition metal composite oxide and a lithium-transition metal phosphate compound, and the like. The lithium-transition metal composite oxide is an oxide containing Li and one or two or more transition metal elements as constituent elements. The lithium-transition metal phosphate compound is a phosphate compound containing Li and one or two or more transition metal elements as constituent elements. The transition metal element is advantageously one or more of Co, Ni, Mn, Ti and Fe, and the like. Examples of the lithium-transition metal composite oxide may include, for example, lithium cobaltate (LiCoO₂), lithium manganate (LiMn₂O₄), lithium nickelate (LiNiO₂) and lithium titanate, and the like. Examples of the lithium-transition metal phosphate compound may include, for example, lithium iron phosphate (LiFePO₄) and LiFe₁₋ᵤMnᵤPO₄ (0<u<1), and the like.

In an embodiment of the present application, in the positive electrode composite material, the positive electrode active material includes a high-nickel positive electrode material of general formula LiNiₓCo_{y}M_{z}O₂, wherein x+y+z=1, 0.8≤x≤1, 0≤y≤0.2, 0≤z≤0.1, and M is selected from one or more of Mn, Al, Mg, Ti, Fe, Cu, Zn, Ga, Zr, Mo, Nb, W and Si. Preferably, in the described positive electrode composite material, the positive electrode active material is the high-nickel positive electrode material of the described general formula.

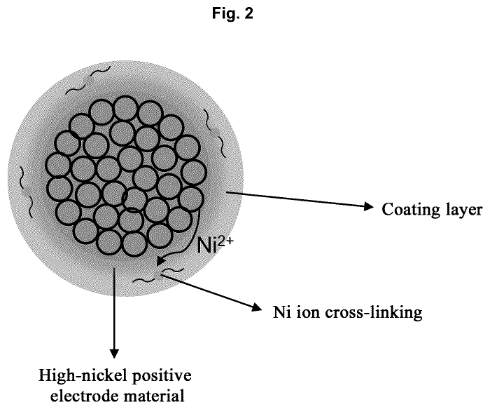

In the positive electrode composite material of the present application, the positive electrode active material including the high-nickel positive electrode material is coated by the coating layer including one or more of a polysaccharide organic polymer, polyvinyl alcohol and polypropylene alcohol, which can effectively prevent contact between the positive electrode active material and an electrolyte in a lithium ion secondary battery, can effectively inhibit side reactions between the positive electrode active material and the electrolyte in the lithium ion secondary battery, reduce the dissolution of transition metals in the positive electrode active material, prevent breaking of the positive electrode active material particles, improve the initial Coulombic efficiency and cycle performance of the lithium ion secondary battery, and can also reduce residual alkali on the surface of the high-nickel positive electrode material. Moreover, excessive Ni ions (Ni²⁺) on the surface of the high-nickel positive electrode material may be cross-linked with the coating layer including one or more of a polysaccharide organic polymer, polyvinyl alcohol and polypropylene alcohol; and when a charging voltage Ec>4.1V (with respect to Li⁺), the coating layer will not be decomposed, which not only can improve the structural stability and conductivity of the coating layer, but also can reduce the phenomenon of lithium-nickel (Li⁺/Ni²⁺) mixed arrangement. FIG. 2 shows a schematic structural diagram of a positive electrode composite material including a high-nickel positive electrode material. It can be obviously seen from FIG. 2 that excessive Ni ions (Ni²⁺) on the surface of the high-nickel positive electrode material and the coating layer form Ni ion cross-linking.

The ratio (I_{003/104}) of intensities of diffraction peaks of a (003) plane and a (104) plane can be obtained from the result of X-ray diffraction (XRD); if the obtained I_{003/104} value is larger, it indicates that the degree of lithium-nickel (Li⁺/Ni²⁺) mixed arrangement is smaller.

In an embodiment of the present application, in order to more effectively inhibit side reactions between the positive electrode active material and an electrolyte in the lithium ion secondary battery and more effectively improve the initial Coulombic efficiency and cycle performance of the lithium ion secondary battery, the polysaccharide organic polymer can be selected from one or more of sodium alginate, Arabic gum and guar gum.

In an embodiment of the present application, in the positive electrode composite material of the present application, based on 100 parts by mass of the positive electrode active material, the amount of the coating layer is in the range of 0.01 parts by mass to 3.5 parts by mass, preferably, the amount of the coating layer is in the range of 0.01 parts by mass to 2.5 parts by mass, and more preferably, the amount of the coating layer is in the range of 0.01 parts by mass to 0.1 parts by mass. By controlling the amount of the coating layer within the range above, a good coating effect of the coating layer on the positive electrode active material can be achieved, and the initial Coulombic efficiency and the capacity retention rate after 100 cycles of the lithium ion secondary battery can be further improved. In cases where the positive electrode active material includes the high-nickel positive electrode material, by controlling the amount of the coating layer to be within the range above, in addition to being able to improve the initial Coulombic efficiency and the capacity retention rate after 100 cycles of the lithium ion secondary battery, residual alkali on the surface of the high-nickel positive electrode material can also be reduced and the phenomenon of lithium-nickel (Li⁺/Ni²⁺) mixed arrangement can be reduced.

Specifically, based on 100 parts by mass of the positive electrode active material, the amount of the coating layer may be in the following ranges: 0.01 parts by mass to 3.5 parts by mass, 0.01 parts by mass to 3.3 parts by mass, 0.01 parts by mass to 3.1 parts by mass, 0.01 parts by mass to 2.9 parts by mass, 0.01 parts by mass to 2.7 parts by mass, 0.01 parts by mass to 2.5 parts by mass, 0.01 parts by mass to 2.3 parts by mass, 0.01 parts by mass to 2.1 parts by mass, 0.01 parts by mass to 1.9 parts by mass, 0.01 parts by mass to 1.7 parts by mass, 0.01 parts by mass to 1.5 parts by mass, 0.01 parts by mass to 1.3 parts by mass, 0.01 parts by mass to 1.1 parts by mass, 0.01 parts by mass to 0.9 parts by mass, 0.01 parts by mass to 0.7 parts by mass, 0.01 parts by mass to 0.5 parts by mass, 0.01 parts by mass to 0.3 parts by mass, 0.01 parts by mass to 0.1 parts by mass, 0.1 parts by mass to 3.5 parts by mass, 0.1 parts by mass to 3.3 parts by mass, 0.1 parts by mass to 3.1 parts by mass, 0.1 parts by mass to 2.9 parts by mass, 0.1 parts by mass to 2.7 parts by mass, 0.1 parts by mass to 2.5 parts by mass, 0.1 parts by mass to 2.3 parts by mass, 0.1 parts by mass to 2.1 parts by mass, 0.1 parts by mass to 1.9 parts by mass, 0.1 parts by mass to 1.7 parts by mass, 0.1 parts by mass to 1.5 parts by mass, 0.1 parts by mass to 1.3 parts by mass, 0.1 parts by mass to 1.1 parts by mass, 0.1 parts by mass to 0.9 parts by mass, 0.1 parts by mass to 0.7 parts by mass, 0.1 parts by mass to 0.5 parts by mass, or 0.1 parts by mass to 0.3 parts by mass.

In an embodiment of the present application, in the positive electrode composite material of the present application, the thickness of the coating layer is in the range of 1 nm to 100 nm, preferably, the thickness of the coating layer is in the range of 1 nm to 80 nm, and more preferably, the thickness of the coating layer is in the range of 1 nm to 60 nm. By controlling the thickness of the coating layer to be within the range above, the initial Coulombic efficiency and the capacity retention rate after 100 cycles of the lithium ion secondary battery can be improved.

Specifically, the thickness of the coating layer may be in the following ranges: 1 nm to 100 nm, 1 nm to 90 nm, 1 nm to 80 nm, 1 nm to 70 nm, 1 nm to 60 nm, 1 nm to 50 nm, 1 nm to 40 nm, 1 nm to 30 nm, 1 nm to 20 nm, 1 nm to 10 nm, 5 nm to 100 nm, 5 nm to 90 nm, 5 nm to 80 nm, 5 nm to 70 nm, 5 nm to 60 nm, 5 nm to 50 nm, 5 nm to 40 nm, 5 nm to 30 nm, 5 nm to 20 nm, or 5 nm to 10 nm.

In another typical embodiment of the present application, provided is a method for preparing a positive electrode composite material, the method including: a first step: adding water into a coating agent including one or more of a polysaccharide organic polymer, polyvinyl alcohol and polypropylene alcohol to obtain a first mixture, and then stirring the first mixture to obtain a coating solution; and a second step: adding a positive electrode active material into the coating solution to obtain a second mixture, then stirring the second mixture, adding an organic solvent during stirring to obtain a third mixture, performing suction filtration on the third mixture, and drying substances subjected to the suction filtration, to obtain the positive electrode composite material.

By the first step, a uniform coating solution can be obtained; and by the second step, the coating agent including one or more of a polysaccharide organic polymer, polyvinyl alcohol and polypropylene alcohol can be uniformly coated on the surface of the positive electrode active material. The positive electrode composite material obtained by the described method of the present application can effectively prevent contact between the positive electrode active material and an electrolyte in a lithium ion secondary battery, can effectively inhibit side reactions between the positive electrode active material and the electrolyte in the lithium ion secondary battery, reduce the dissolution of transition metals in the positive electrode active material, prevent breaking of the positive electrode active material particles, and improve the initial Coulombic efficiency and cycle performance of the lithium ion secondary battery. Furthermore, in the positive electrode composite material obtained by the described method of the present application, the coating layer coating the positive electrode active material is water-soluble; and during the preparation of a positive electrode sheet, an oil-based slurry system is usually used, the water-soluble coating layer of the positive electrode composite material prepared by the method of the present application can well maintain the own structural integrity in the oil-based slurry and electrode sheet system. Compared with a method for coating a positive electrode sheet in the prior art, the method of the present application has a better coating effect on the positive electrode active material, the initial Coulombic efficiency and cycle performance of the lithium ion secondary battery can be more significantly improved thereby.

In an embodiment of the present application, in the method for preparing the positive electrode composite material, in the second step, the substances subjected to the suction filtration can be dried under a vacuum condition, alternatively, the substances subjected to the suction filtration can be dried by means of a baking manner, and preferably, the substances subjected to the suction filtration can be baked under a vacuum condition.

In another typical embodiment of the present application, provided is a method for preparing a positive electrode composite material, the method including: a first step: adding water into a coating agent including one or more of a polysaccharide organic polymer, polyvinyl alcohol and polypropylene alcohol to obtain a first mixture, and then stirring the first mixture to obtain a coating solution; and a second step: adding a positive electrode active material into the coating solution to obtain a second mixture, then placing the second mixture in a water bath and stirring same, and drying remaining substances after water in the second mixture is evaporated, to obtain the positive electrode composite material.

Similarly, by the first step, a uniform coating solution can be obtained; and by the second step, the coating agent including one or more of a polysaccharide organic polymer, polyvinyl alcohol and polypropylene alcohol can be uniformly coated on the surface of the positive electrode active material. The positive electrode composite material obtained by the described method of the present application can effectively prevent contact between the positive electrode active material and an electrolyte in a lithium ion secondary battery, can effectively inhibit side reactions between the positive electrode active material and the electrolyte in the lithium ion secondary battery, reduce the dissolution of transition metals in the positive electrode active material, prevent breaking of the positive electrode active material particles, and improve the initial Coulombic efficiency and cycle performance of the lithium ion secondary battery. Furthermore, in the positive electrode composite material obtained by the described method of the present application, the coating layer coating the positive electrode active material is water-soluble; and during the preparation of a positive electrode sheet, an oil-based slurry system is usually used, the water-soluble coating layer of the positive electrode composite material prepared by the method of the present application can well maintain the own structural integrity in the oil-based slurry and electrode sheet system. Compared with a method for coating a positive electrode sheet in the prior art, the method of the present application has a better coating effect on the positive electrode active material, the initial Coulombic efficiency and cycle performance of the lithium ion secondary battery can be more significantly improved thereby.

In an embodiment of the present application, in the method for preparing the positive electrode composite material, in the second step, the remaining substances can be dried under a vacuum condition, alternatively, the remaining substances can be dried by means of a baking manner, and preferably, the remaining substances can be baked under a vacuum condition.

In an embodiment of the present application, in the method for preparing the positive electrode composite material, in the first step, the stirring speed is in the range of 50-500 rpm, and the stirring time is in the range of 0.5-12 h; preferably, the stirring speed is in the range of 100-500 rpm, and the stirring time is in the range of 1-12 h; more preferably, the stirring speed is in the range of 200-400 rpm, and the stirring time is in the range of 1-8 h; and most preferably, the stirring speed is in the range of 250-350 rpm, and the stirring time is in the range of 1-6 h. By controlling the stirring speed and the stirring time in the first step to be within the described ranges, a uniform coating solution can be obtained, a good coating effect of the coating layer on the positive electrode active material can be achieved, and the initial Coulombic efficiency and the capacity retention rate after 100 cycles of the lithium ion secondary battery can be further improved. In cases where the positive electrode active material includes a high-nickel positive electrode material, by controlling the stirring speed and the stirring time in the first step to be within the ranges above, in addition to being able to obtain the effects as mentioned above, the phenomenon of lithium-nickel (Li⁺/Ni²⁺) mixed arrangement can be significantly reduced.

In an embodiment of the present application, in the method for preparing the positive electrode composite material, in order to obtain a coating solution of an appropriate concentration and to achieve a good coating effect, in the first step, based on 100 parts by mass of the coating solution, the amount of the coating agent is in the range of 0.01 parts by mass to 3.5 parts by mass, and preferably, the amount of the coating agent is in the range of 0.01 parts by mass to 2.5 parts by mass, and more preferably, the amount of the coating agent is in the range of 0.01 parts by mass to 0.1 parts by mass.

In an embodiment of the present application, in the method for preparing the positive electrode composite material, in order to achieve a good coating effect, in the second step, the stirring speed is in the range of 100-500 rpm, preferably, the stirring speed is in the range of 200-500 rpm, and more preferably, the stirring speed is in the range of 300-500 rpm. Specifically, in the second step, the stirring speed may be in the following ranges: 100-450 rpm, 100-400 rpm, 100-350 rpm, 100-300 rpm, 100-250 rpm, 100-200 rpm, 100-150 rpm, 150-450 rpm, 150-400 rpm, 150-350 rpm, 150-300 rpm, 150-250 rpm, or 150-200 rpm.

In an embodiment of the present application, in the described method for preparing the positive electrode composite material, in the second step, based on the total weight of the second mixture, the content of the positive electrode active material in the second mixture is in the range of 4.0 wt %-60 wt %; preferably, based on the total weight of the second mixture, the content of the positive electrode active material in the second mixture is in the range of 35 wt %-55 wt %; and more preferably, based on the total weight of the second mixture, the content of the positive electrode active material in the second mixture is in the range of 45 wt %-50 wt %. By controlling the content of the positive electrode active material in the second mixture to be within the described range, it can be ensured that a good coating effect is obtained, and it can be ensured that the initial Coulombic efficiency and the capacity retention rate after 100 cycles of the lithium ion secondary battery are improved. In cases where the positive electrode active material includes a high-nickel positive electrode material, by controlling the content of the positive electrode active material in the second mixture to be within the described range, in addition to being able to ensure that the effects as mentioned above are obtained, it can also be ensured that the residual alkali on the surface of the high-nickel positive electrode material is reduced, and it can be ensured the phenomenon of lithium-nickel (Li⁺/Ni²⁺) mixed arrangement is reduced.

Specifically, in the second step, based on the total weight of the second mixture, the content of the positive electrode active material in the second mixture may be in the following ranges: 10 wt %-60 wt %, 15 wt %-60 wt %, 20 wt %-60 wt %, 25 wt %-60 wt %, 30 wt %-60 wt %, 35 wt %-60 wt %, 40 wt %-60 wt %, 45 wt %-60 wt %, 50 wt %-60 wt %, 55 wt %-60 wt %, 10 wt %-50 wt %, 15 wt %-50 wt %, 20 wt %-50 wt %, 25 wt %-50 wt %, 30 wt %-50 wt %, 35 wt %-50 wt %, 40 wt %-50 wt %, or 45 wt %-55 wt %.

In an embodiment of the present application, in the method for preparing the positive electrode composite material, in the second step, the organic solvent is selected from one of ethanol, isopropanol and ethylene glycol. Water in the second mixture can be replaced by the organic solvent, so as to ensure that the washed residual alkali remains in the water and leaves along with suction filtration, and in this way, the content of the residual alkali in the positive electrode composite material obtained after coating can be significantly reduced.

In an embodiment of the present application, in the method for preparing the positive electrode composite material, the addition amount of the organic solvent may be 50%-100% of the mass of the coating solution, or the addition amount of the organic solvent may be 60%-90% of the mass of the coating solution, or the addition amount of the organic solvent may be 70%-80% of the mass of the coating solution, or the addition amount of the organic solvent may be 90%-100% of the mass of the coating solution. The more the addition amount of the organic solvent, the more obvious the effect of replacing water by the organic solvent. Best of all, the addition amount of the organic solvent is consistent with the mass of the coating solution, that is, most preferably, the addition amount of the organic solvent is 100% of the mass of the coating solution.

In an embodiment of the present application, in the method for preparing the positive electrode composite material, in the second step, the drying temperature is in the range of 60-120° C., and the drying time is in the range of 2-12 h; preferably, the drying temperature is in the range of 80-120° C., and the drying time is in the range of 4-12 h; more preferably, the drying temperature is in the range of 90-120° C., and the drying time is in the range of 8-12 h; further preferably, the drying temperature is in the range of 100-120° C., and the drying time is in the range of 8-10 h; and most preferably, the drying temperature is in the range of 110-120° C., and the drying time is in the range of 6-8 h. By controlling the drying temperature and the drying time in the second step to be within the ranges above, a good coating effect can be obtained, and the charge capacity, the initial Coulombic efficiency and the capacity retention rate after 100 cycles of the lithium ion secondary battery can be improved. In cases where the positive electrode active material includes the high-nickel positive electrode material, by controlling the drying temperature and the drying time in the second step to be within the ranges above, in addition to being able to obtain the effects as mentioned above, the residual alkali on the surface of the high-nickel positive electrode material can also be reduced, and the phenomenon of lithium-nickel (Li⁺/Ni²⁺) mixed arrangement can be reduced.

In an embodiment of the present application, in the method for preparing the positive electrode composite material, in order to achieve a good coating effect, in the second step, the temperature of the water bath is in the range of 60-100° C., preferably, the temperature of the water bath is in the range of 70-90° C., and more preferably, the temperature of the water bath is in the range of 70-80° C. The described temperature of the water bath can ensure that the water in the second mixture is evaporated at a uniform speed without being too fast, so that the coating agent is uniformly coated on the surface of the positive electrode active material during the evaporation of the water.

In an embodiment of the present application, in the method for preparing the positive electrode composite material, the positive electrode active material includes a high-nickel positive electrode material of general formula LiNiₓCo_{y}M_{z}O₂, wherein x+y+Z=1, 0.8≤x≤1, 0≤y≤0.2, 0≤z≤0.1, and M is selected from one or more of Mn, Al, Mg, Ti, Fe, Cu, Zn, Ga, Zr, Mo, Nb, W and Si. Preferably, in the described method for preparing the positive electrode composite material, the positive electrode active material is the high-nickel positive electrode material of the described general formula. In the method for preparing the positive electrode composite material of the present application, in cases where the positive electrode active material includes the high-nickel positive electrode material, the same effects as those in the described positive electrode composite material can be obtained.

In an embodiment of the present application, in the method for preparing the positive electrode composite material, the polysaccharide organic polymer is selected from one or more of sodium alginate, Arabic gum and guar gum. In the situation above, the same effects as those in the described positive electrode composite material can be obtained.

In an embodiment of the present application, in the method for preparing the positive electrode composite material, based on 100 parts by mass of the positive electrode active material, the amount of the coating agent is in the range of 0.01 parts by mass to 3.5 parts by mass, preferably, the amount of the coating agent is in the range of 0.01 parts by mass to 2.5 parts by mass, and more preferably, the amount of the coating agent is in the range of 0.01 parts by mass to 0.1 parts by mass. By controlling the amount of the coating agent within the range above, a good coating effect of the coating agent on the positive electrode active material can be achieved, and the initial Coulombic efficiency and the capacity retention rate after 100 cycles of the lithium ion secondary battery can be further improved. In cases where the positive electrode active material includes the high-nickel positive electrode material, by controlling the amount of the coating agent to be within the range above, in addition to being able to further improve the initial Coulombic efficiency and the capacity retention rate after 100 cycles of the lithium ion secondary battery, residual alkali on the surface of the high-nickel positive electrode material can also be reduced and the phenomenon of lithium-nickel (Li⁺/Ni²⁺) mixed arrangement can be reduced.

In still another typical embodiment of the present application, provided is a positive electrode of a lithium ion secondary battery, the positive electrode of a lithium ion secondary battery including the positive electrode composite material as described above. As the positive electrode of a lithium ion secondary battery of the present application includes the positive electrode composite material as described above, the positive electrode can effectively inhibit side reactions between the positive electrode active material and the electrolyte in the lithium ion secondary battery, reduce the dissolution of transition metals in the positive electrode active material, prevent breaking of the positive electrode active material particles, and improve the initial Coulombic efficiency and cycle performance of the lithium ion secondary battery.

In still another typical embodiment of the present application, provided is a lithium ion secondary battery, the lithium ion secondary battery including: a positive electrode, a negative electrode and a separator, the positive electrode including the positive electrode composite material as described above. As the lithium ion secondary battery of the present application includes the positive electrode composite material as described above, the lithium ion secondary battery can effectively inhibit side reactions between the positive electrode active material and the electrolyte in the lithium ion secondary battery, reduce the dissolution of transition metals in the positive electrode active material, prevent breaking of the positive electrode active material particles, and improve the initial Coulombic efficiency and cycle performance of the lithium ion secondary battery.

The positive electrode of the present application includes a positive electrode current collector and a positive electrode active material layer including the positive electrode composite material. The positive electrode active material layer is formed on both surfaces of the positive electrode current collector. A metal foil such as an aluminum foil, a nickel foil, or a stainless steel foil may be used as the positive electrode current collector.

The negative electrode of the present application includes a negative electrode current collector and a negative electrode active material layer including a negative electrode active material. The negative electrode active material layer is formed on both surfaces of the negative electrode current collector. A metal foil such as a copper (Cu) foil, a nickel foil, or a stainless steel foil may be used as the negative electrode current collector.

The negative electrode active material layer includes, as a negative electrode active material, one or more negative electrode materials capable of intercalating and de-intercalating lithium ions, and may include, as necessary, another material, for example, a negative electrode binder and/or a negative electrode conductive agent. The negative electrode active material may be selected from one or more of lithium metal, a lithium alloy, a carbon material, silicon or tin and oxides thereof.

The separator of the present application is used to separate the positive electrode from the negative electrode in the battery, and allow lithium ions to pass therethrough, while preventing current short-circuiting due to contact between the positive electrode and the negative electrode. The separator is, for example, a porous membrane formed of a synthetic resin or ceramic, and may be a laminated membrane in which two or more porous membranes are laminated. Examples of the synthetic resin include, for example, polytetrafluoroethylene, polypropylene and polyethylene, and the like.

In an embodiment of the present application, when the lithium ion secondary battery is charged, for example, lithium ions are de-intercalated from the positive electrode and are intercalated into the negative electrode through the electrolyte impregnated in the separator. When the lithium ion secondary battery is discharged, for example, lithium ions are de-intercalated from the negative electrode and are intercalated into the positive electrode through the electrolyte impregnated in the separator.

Hereinafter, the present application will be described in further detail including with examples, and these examples cannot be understood as limiting the scope of protection of the present application.

### Example 1

1. 0.01 g of sodium alginate was weighed and placed into a beaker, water was added to 100 g, and stirring was performed at 300 rpm for 1 hour, to obtain a 0.01 wt % sodium alginate solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 2

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 3

1. 2.5 g of sodium alginate was weighed and placed into a beaker, water was added to 100 g, and stirring was performed at 300 rpm for 1 hour, to obtain a 2.5 wt % sodium alginate solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 4

1. 3.5 g of sodium alginate was weighed and placed into a beaker, water was added to 100 g, and stirring was performed at 300 rpm for 1 hour, to obtain a 3.5 wt % sodium alginate solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 5

1. 0.1 g of polyvinyl alcohol was weighed and placed into a beaker, water was added to 100 g, and stirring was performed at 300 rpm for 1 hour, to obtain a 0.1 wt % polyvinyl alcohol solution;

2. 100 g of lithium cobaltate (LiCoO₂) was weighed and added to the solution in step 1, placed in a water bath kettle and stirring was performed, until water in the solution was evaporated to be dry, and the remaining substances were baked to obtain coated lithium cobaltate, wherein the stirring speed was 200 rpm, the temperature of the water bath was 100° C., the drying temperature was 120° C., and the drying time was 8 hours; and

3. 97 g of the material prepared by the described process, 1.5 g of conductive carbon black as a conductive agent and 1.5 g of polyvinylidene fluoride (PVDF) as a binder were taken to prepare an electrode sheet, and the electrode sheet was used to prepare a half-cell; and the results thereof are as shown in Table 1.

### Example 6

1. 0.01 g of Arabic gum was weighed and placed into a beaker, water was added to 100 g, and stirring was performed at 300 rpm for 1 hour, to obtain a 0.01 wt % Arabic gum solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 7

1. 0.1 g of Arabic gum was weighed and placed into a beaker, water was added to 100 g, and stirring was performed at 300 rpm for 1 hour, to obtain a 0.1 wt % Arabic gum solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 8

1. 2.5 g of Arabic gum was weighed and placed into a beaker, water was added to 100 g, and stirring was performed at 300 rpm for 1 hour, to obtain a 2.5 wt % Arabic gum solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 9

1. 3.5 g of Arabic gum was weighed and placed into a beaker, water was added to 100 g, and stirring was performed at 300 rpm for 1 hour, to obtain a 3.5 wt % Arabic gum solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 10

1. 0.1 g of guar gum was weighed and placed into a beaker, water was added to 100 g, and stirring was performed at 300 rpm for 1 hour, to obtain a 0.1 wt % guar gum solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 11

1. 0.1 g of sodium alginate was weighed and placed into a beaker, water was added to 100 g, and stirring was performed at 50 rpm for half an hour, to obtain a 0.1 wt % sodium alginate solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 12

1. 0.1 g of sodium alginate was weighed and placed into a beaker, water was added to 100 g, and stirring was performed at 300 rpm for 1 hour, to obtain a 0.1 wt % sodium alginate solution;

2. 150 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 13

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 60° C., and the drying time was 2 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 14

1. 0.1 g of polypropylene alcohol was weighed and placed into a beaker, water was added to 100 g, and stirring was performed at 300 rpm for 1 hour, to obtain a 0.1 wt % polypropylene alcohol solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 15

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.8}Co_{0.1}Al_{0.1}O₂) was weighed and added to the solution in step 1, placed in a water bath kettle and stirring was performed, until water in the solution was evaporated to be dry, and the remaining substances were baked to obtain a coated high-nickel positive electrode material, wherein the stirring speed was 200 rpm, the temperature of the water bath was 100° C., the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 16

1. 0.1 g of polyvinyl alcohol was weighed and placed into a beaker, water was added to 100 g, and stirring was performed at 300 rpm for 1 hour, to obtain a 0.1 wt % polyvinyl alcohol solution;

2. 100 g of a high-nickel positive electrode material (LiNi_{0.8}Co_{0.1}Al_{0.1}O₂) was weighed and added to the solution in step 1, placed in a water bath kettle and stirring was performed, until water in the solution was evaporated to be dry, and the remaining substances were baked to obtain a coated high-nickel positive electrode material, wherein the stirring speed was 200 rpm, the temperature of the water bath was 60° C., the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 17

1. 0.1 g of Arabic gum was weighed and placed into a beaker, water was added to 100 g, and stirring was performed at 300 rpm for 1 hour, to obtain a 0.1 wt % Arabic gum solution;

2. 100 g of a high-nickel positive electrode material (LiNi_{0.8}Co_{0.1}Al_{0.1}O₂) was weighed and added to the solution in step 1, placed in a water bath kettle and stirring was performed, until water in the solution was evaporated to be dry, and the remaining substances were baked to obtain a coated high-nickel positive electrode material, wherein the stirring speed was 200 rpm, the temperature of the water bath was 100° C., the drying temperature was 120° C., and the drying time was 12 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 18

1. 0.1 g of guar gum was weighed and placed into a beaker, water was added to 100 g, and stirring was performed at 300 rpm for 1 hour, to obtain a 0.1 wt % guar gum solution;

2. 100 g of a high-nickel positive electrode material (LiNi_{0.8}Co_{0.1}Al_{0.1}O₂) was weighed and added to the solution in step 1, placed in a water bath kettle and stirring was performed, until water in the solution was evaporated to be dry, and the remaining substances were baked to obtain a coated high-nickel positive electrode material, wherein the stirring speed was 200 rpm, the temperature of the water bath was 100° C., the drying temperature was 80° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 19

1. 0.1 g of polypropylene alcohol was weighed and placed into a beaker, water was added to 100 g, and stirring was performed at 300 rpm for 1 hour, to obtain a 0.1 wt % polypropylene alcohol solution;

2. 100 g of a high-nickel positive electrode material (LiNi_{0.8}Co_{0.1}Al_{0.1}O₂) was weighed and added to the solution in step 1, placed in a water bath kettle and stirring was performed, until water in the solution was evaporated to be dry, and the remaining substances were baked to obtain a coated high-nickel positive electrode material, wherein the stirring speed was 200 rpm, the temperature of the water bath was 100° C., the drying temperature was 120° C., and the drying time was 4 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 20

1. 0.1 g of sodium alginate was weighed and placed into a beaker, water was added to 100 g, and stirring was performed at 100 rpm for 12 hour, to obtain a 0.1 wt % sodium alginate solution;

2. 4.2 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 100 rpm, the drying temperature was 120° C., and the drying time was 8 hours; and

3. the material prepared by the described process was taken, an acid-base titration method was used to test residual alkali, I_{003/104} was obtained according to an XRD result, and 3.6 g of the prepared material, 0.2 g of conductive carbon black as a conductive agent and 0.2 g of polyvinylidene fluoride (PVDF) as a binder were used to prepare an electrode sheet, and the electrode sheet was used to prepare a half-cell; and the results thereof are as shown in Table 1.

### Example 21

1. 0.1 g of sodium alginate was weighed and placed into a beaker, water was added to 100 g, and stirring was performed at 500 rpm for 1 hour, to obtain a 0.1 wt % sodium alginate solution;

2. 100 g of a high-nickel positive electrode material (LiNi_{0.8}Co_{0.1}Al_{0.1}O₂) was weighed and added to the solution in step 1, stirring continued for half an hour, 100 g of isopropanol was added dropwise in the midway, suction filtration was performed, and the substances subjected to the suction filtration were baked to obtain a coated high-nickel positive electrode material, wherein the stirring speed was 100 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 22

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.8}Co_{0.1}Al_{0.1}O₂) was weighed and added to the solution in step 1, stirring continued for half an hour, 50 g of ethylene glycol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 23

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Al_{0.05}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 24

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.8}Co_{0.1}Mn_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 25

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Mn_{0.05}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 26

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Al_{0.03}Mg_{0.02}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 27

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Al_{0.03} Ti_{0.02}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 28

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Al_{0.03}Fe_{0.02}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 29

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Al_{0.03}Cu_{0.02}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 30

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Al_{0.03}Zn_{0.02}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 31

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Al_{0.03}Ga_{0.02}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 32

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Al_{0.03}Zr_{0.02}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 33

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Al_{0.03}Mo_{0.02}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 34

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Al_{0.03}Nb_{0.02}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 35

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Al_{0.03}W_{0.02}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 36

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.9}Co_{0.05}Al_{0.03}Si_{0.02}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Example 37

1. 0.05 g of sodium alginate and 0.05 g of guar gum were weighed and placed into a beaker, water was added to 100 g, and stirring was performed at 300 rpm for 1 hour, to obtain a 0.1 wt % sodium alginate/guar gum solution;

2. 100 g of a high-nickel positive electrode material (LiNi_{0.8}Co_{0.1}Al_{0.1}O₂) was weighed and added to the solution in step 1, stirring continued for half an hour, 100 g of ethanol was added dropwise in the midway, suction filtration was performed, and the substances subjected to the suction filtration were baked to obtain a coated high-nickel positive electrode material, wherein the stirring speed was 500 rpm, the drying temperature was 120° C., and the drying time was 8 hours; and

3. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Comparative Example 1

1. A high-nickel positive electrode material (LiNi_{0.8}Co_{0.1}Al_{0.1}O₂) was taken, an acid-base titration method was used to test residual alkali, I_{003/104} was obtained according to an XRD result, and 90 g of the high-nickel positive electrode material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Comparative Example 2

1. 0.1 g of sodium alginate was weighed and placed into a beaker, water was added to 100 g, and stirring was performed at 300 rpm for 1 hour, to obtain a 0.1 wt % sodium alginate solution;

2. 100 g of a high-nickel positive electrode material (LiNi_{0.8}Co_{0.1}Al_{0.1}O₂) was taken, and mixed with 5.6 g of conductive carbon black as a conductive agent and 5.6 g of polyvinylidene fluoride (PVDF) as a binder to form an electrode sheet, and the electrode sheet was baked;

3. the electrode sheet was taken, the coating solution formulated in step 1 was dipped by using a coating rod and smeared on the electrode sheet, and the smeared electrode sheet was baked to obtain an electrode sheet coated with a coating layer; and

4. the electrode sheet was taken to prepare a half-cell, and then tests were performed; and the results thereof are as shown in Table 1.

### Comparative Example 3

1. 0.1 g of sodium alginate was weighed and placed into a beaker, a copolymer of maleic acid and acrylic acid was added to 100 g, and stirring was performed at 300 rpm for 1 hour, to obtain a 0.1 wt % sodium alginate resin solution;

2. 100 g of a high-nickel positive electrode material (LiNi_{0.8}Co_{0.1}Al_{0.1}O₂) was weighed and placed into a stirrer for stirring, wherein the stirring time was 30 min, and the stirring speed was 300 rpm;

3. the sodium alginate resin solution formulated in step 1 was taken and added dropwise into the high-nickel positive electrode material in step 2, and heated up to 80° C. under a stirring state, and the temperature was maintained for 1 h, so as to obtain a high-nickel positive electrode material coated with sodium alginate; and

4. the material prepared by the described process was taken, an acid-base titration method was used to test residual alkali, I_{003/104} was obtained according to an XRD result, and 90 g of the prepared material, 5 g of conductive carbon black as a conductive agent and 5 g of polyvinylidene fluoride (PVDF) as a binder were used to prepare an electrode sheet, and the electrode sheet was used to prepare a half-cell; and the results thereof are as shown in Table 1.

### Test of Cell Performance

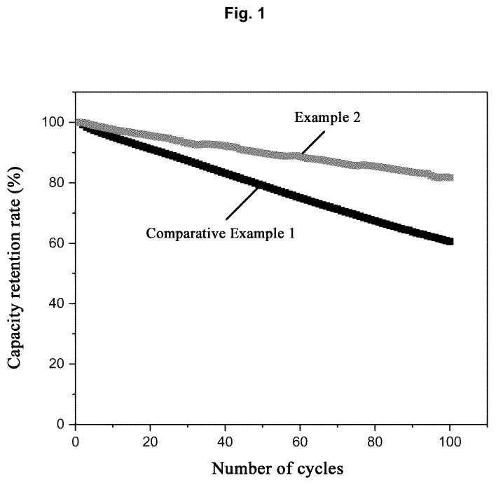

The half-cells in Examples 1-37 and Comparative Examples 1-3 were subjected to a charge and discharge test at a voltage of 2.5-4.25 V under room temperature. The half-cells in the Examples and Comparative Examples were first subjected to one cycle test of 0.1 C at 25° C., to determine the initial charge capacity and the initial Coulombic efficiency of the cell, and then subjected to a cycle test of 1 C charging and 5 C discharging at 60° C. for 100 times, to determine the capacity retention rate of the cell after 100 cycles. The experimental results are shown in Table 1 below and in FIG. 1.

TABLE 1
Physical properties of materials and electrochemical performance test results

| | | | | | Capacity |
|---|---|---|---|---|---|
| | Residual | | Initial charge | Initial | retention rate |
| | alkali | | capacity | Coulombic | after 100 cycles |
| Experiment No. | (wt %) | I_{003/104} | (mAh/g) | efficiency (%) | (%) |
| Example 1 | 0.07 | 1.82 | 222 | 91.2 | 80.1 |
| Example 2 | 0.07 | 1.82 | 222 | 91.5 | 81.8 |
| Example 3 | 0.07 | 1.82 | 219 | 91.0 | 80.0 |
| Example 4 | 0.07 | 1.82 | 219 | 91.0 | 79.9 |
| Example 5 | — | — | 197 | 96.3 | 80.9 |
| Example 6 | 0.07 | 1.80 | 222 | 91.1 | 80.0 |
| Example 7 | 0.07 | 1.80 | 222 | 91.4 | 81.7 |
| Example 8 | 0.07 | 1.80 | 218 | 91.0 | 79.9 |
| Example 9 | 0.07 | 1.80 | 218 | 91.0 | 79.8 |
| Example 10 | 0.07 | 1.81 | 221 | 90.8 | 81.6 |
| Example 11 | 0.07 | 1.72 | 220 | 90.7 | 81.0 |
| Example 12 | 0.22 | 1.61 | 220 | 91.0 | 80.0 |
| Example 13 | 0.19 | 1.80 | 220 | 90.8 | 80.5 |
| Example 14 | 0.07 | 1.80 | 222 | 91.3 | 81.6 |
| Example 15 | 0.12 | 1.70 | 221 | 90.8 | 80.1 |
| Example 16 | 0.12 | 1.70 | 221 | 90.6 | 80.0 |
| Example 17 | 0.12 | 1.70 | 221 | 90.7 | 80.9 |
| Example 18 | 0.19 | 1.70 | 220 | 90.5 | 80.7 |
| Example 19 | 0.19 | 1.70 | 220 | 90.6 | 80.6 |
| Example 20 | 0.07 | 1.82 | 222 | 91.3 | 80.8 |
| Example 21 | 0.09 | 1.80 | 221 | 91.3 | 80.7 |
| Example 22 | 0.10 | 1.80 | 220 | 91.0 | 80.4 |
| Example 23 | 0.07 | 1.82 | 225 | 91.6 | 81.7 |
| Example 24 | 0.07 | 1.82 | 222 | 91.4 | 81.7 |
| Example 25 | 0.07 | 1.82 | 225 | 91.6 | 81.6 |
| Example 26 | 0.07 | 1.82 | 225 | 91.5 | 81.5 |
| Example 27 | 0.07 | 1.82 | 225 | 91.6 | 81.4 |
| Example 28 | 0.07 | 1.82 | 224 | 91.6 | 81.4 |
| Example 29 | 0.07 | 1.82 | 225 | 91.4 | 81.5 |
| Example 30 | 0.07 | 1.82 | 225 | 91.5 | 81.4 |
| Example 31 | 0.07 | 1.82 | 223 | 91.3 | 81.7 |
| Example 32 | 0.07 | 1.82 | 226 | 91.7 | 81.7 |
| Example 33 | 0.07 | 1.82 | 224 | 91.4 | 81.4 |
| Example 34 | 0.07 | 1.82 | 224 | 91.3 | 81.4 |
| Example 35 | 0.07 | 1.82 | 224 | 91.4 | 81.5 |
| Example 36 | 0.07 | 1.82 | 223 | 91.3 | 81.3 |
| Example 37 | 0.07 | 1.82 | 222 | 91.5 | 81.9 |
| Comparative Example 1 | 0.24 | 1.56 | 220 | 89.2 | 60.6 |
| Comparative Example 2 | — | — | 220 | 90.6 | 70.6 |
| Comparative Example 3 | 0.26 | 1.55 | 221 | 90.7 | 70.8 |

By comparing the results of Examples 1-37 with those of Comparative Example 1, it can be seen that compared with Comparative Example 1 in which there is no coating layer coating a positive electrode active material, the cells in Examples 1-37 in which the positive electrode composite material includes a coating layer coating a positive electrode active material have higher initial Coulombic efficiency and significantly higher capacity retention rate after 100 cycles.

By comparing the results of Examples 1˜4 and 6-37 with those of Comparative Example 1, it can be seen that in cases where a high-nickel positive electrode material is used, compared with Comparative Example 1 in which there is no coating layer coating the high-nickel positive electrode material, in Examples 1˜4 and 6-37 in which the positive electrode composite material includes a coating layer coating the high-nickel positive electrode material, the residual alkali (wt %) on the surface of the prepared high-nickel positive electrode material is smaller and the 1003/104 value is larger, which demonstrates that the residual alkali on the surface of the high-nickel positive electrode material in Examples 1˜4 and 6-37 is reduced and the phenomenon of lithium-nickel mixed arrangement is reduced; and cells prepared with the positive electrode composite material have higher initial Coulombic efficiency and significantly higher capacity retention rate after 100 cycles.

By comparing the results of Example 2 and Example 15 with those of Comparative Example 2, it can be seen that compared with the method for coating the electrode sheet in Comparative Example 2, the methods in Example 2 and Example 15 of the present application have a better coating effect on the positive electrode active material, improve the initial Coulombic efficiency of the cell and significantly improve the capacity retention rate after 100 cycles.

By comparing the results of Example 2, Example 13, Example 15 and Example 22 with those of Comparative Example 3, it can be seen that compared with the method in Comparative Example 3, the methods in Example 2, Example 13, Example 15 and Example 22 of the present application have a better coating effect on the positive electrode active material, improve the initial Coulombic efficiency of the cell, significantly improve the capacity retention rate after 100 cycles, and reduce residual alkali on the surface of the high-nickel positive electrode material and the phenomenon of lithium-nickel mixed arrangement.

By comparing the results of Examples 1-3 with those of Example 4 and by comparing the results of Examples 6-8 with those of Example 9, it can be seen that based on 100 parts by mass of the positive electrode active material, when the amount of the coating agent is within the range of 0.01 parts by mass to 2.5 parts by mass, the capacity retention rate after 100 cycles is further improved.

It can be seen from the described cell performance test results: the positive electrode composite material, the method for preparing the positive electrode composite material, and the positive electrode and the lithium ion secondary battery which include the positive electrode composite material in the present application, can effectively inhibit side reactions between the positive electrode active material and the electrolyte in the lithium ion secondary battery, reduce the dissolution of transition metals in the positive electrode active material, prevent breaking of the positive electrode active material particles, and improve the initial Coulombic efficiency and cycle performance of the lithium ion secondary battery.

The contents as described above are only preferred examples of the present application and are not intended to limit the present application. For a person skilled in the art, the present application may have various modifications and variations. Any modifications, equivalent replacements, improvements, etc. made within the spirit and principle of the present application shall all fall within the scope of protection of the present application.

1. A positive electrode composite material comprising:
a positive electrode active material; and
a coating layer coating the positive electrode active material, the coating layer comprises one or more of a polysaccharide organic polymer, polyvinyl alcohol and polypropylene alcohol.

2. The positive electrode composite material according to claim 1, wherein the positive electrode active material comprises a high-nickel positive electrode material of general formula LiNiₓCo_{y}M_{z}O₂, wherein x+y+z=1, 0.8≤x≤1, 0≤y≤0.2, 0≤z≤0.1, and M is selected from one or more of Mn, Al, Mg, Ti, Fe, Cu, Zn, Ga, Zr, Mo, Nb, W and Si.

3. The positive electrode composite material according to claim 1, wherein the polysaccharide organic polymer is selected from one or more of sodium alginate, Arabic gum and guar gum.

4. The positive electrode composite material according to claim 1, wherein based on 100 parts by mass of the positive electrode active material, the amount of the coating layer is in the range of 0.01 parts by mass to 3.5 parts by mass.

5. The positive electrode composite material according to claim 1, wherein the thickness of the coating layer is in the range of 1 nm to 100 nm.

6. A method for preparing a positive electrode composite material, the method comprising:
adding water into a coating agent comprising one or more of a polysaccharide organic polymer, polyvinyl alcohol and polypropylene alcohol to obtain a first mixture, and then stirring the first mixture to obtain a coating solution; and
adding a positive electrode active material into the coating solution to obtain a second mixture, then stirring the second mixture, adding an organic solvent during stirring to obtain a third mixture, performing suction filtration on the third mixture, and drying substances subjected to the suction filtration, to obtain the positive electrode composite material.

7. A method for preparing a positive electrode composite material, the method comprising:
adding water into a coating agent comprising one or more of a polysaccharide organic polymer, polyvinyl alcohol and polypropylene alcohol to obtain a first mixture, and then stirring the first mixture to obtain a coating solution; and
adding a positive electrode active material into the coating solution to obtain a second mixture, then placing the second mixture in a water bath and stirring same, and drying remaining substances after water in the second mixture is evaporated, to obtain the positive electrode composite material.

8. The method for preparing the positive electrode composite material according to claim 6, wherein a stirring speed is in a range of 100-500 rpm and a stirring time is in the range of 1-12 h for stirring the first mixture to obtain the coating solution.

9. The method for preparing the positive electrode composite material according to claim 6, wherein based on 100 parts by mass of the coating solution, an amount of the coating agent is in a range of 0.01 parts by mass to 3.5 parts by mass.

10. The method for preparing the positive electrode composite material according to claim 6, wherein a stirring speed is in a range of 100-500 rpm for stirring the second mixture.

11. The method for preparing the positive electrode composite material according to claim 6, wherein based on a total weight of the second mixture, a content of the positive electrode active material in the second mixture is in the range of 4.0 wt %-60 wt %.

12. The method for preparing the positive electrode composite material according to claim 6, wherein the organic solvent is selected from one of ethanol, isopropanol and ethylene glycol.

13. The method for preparing the positive electrode composite material according to claim 6, wherein the addition amount of the organic solvent is 50%-100% of the mass of the coating solution.

14. The method for preparing the positive electrode composite material according to claim 6, wherein a drying temperature is in the range of 80-120° C., and a drying time is in a range of 4-12 h.

15. The method for preparing the positive electrode composite material according to claim 7, wherein a temperature of the water bath is in a range of 60-100° C.

16. The method for preparing the positive electrode composite material according to claim 6, wherein the positive electrode active material comprises a high-nickel positive electrode material of general formula LiNiₓCo_{y}M_{z}O₂, wherein x+y+z=1, 0.8≤x≤1, 0≤y≤0.2, 0≤z≤0.1, and M is selected from one or more of Mn, Al, Mg, Ti, Fe, Cu, Zn, Ga, Zr, Mo, Nb, W and Si.

17. The method for preparing the positive electrode composite material according to claim 6, wherein the polysaccharide organic polymer is selected from one or more of sodium alginate, Arabic gum and guar gum.

18. The method for preparing the positive electrode composite material according to claim 6, wherein based on 100 parts by mass of the positive electrode active material, an amount of the coating agent is in a range of 0.01 parts by mass to 3.5 parts by mass.

19. A positive electrode of a lithium ion secondary battery, wherein the positive electrode of the lithium ion secondary battery comprises the positive electrode composite material according to claim 1.

20. A lithium ion secondary battery, wherein the lithium ion secondary battery comprises:
a positive electrode,
a negative electrode, and
a separator,
wherein the positive electrode comprises the positive electrode composite material according to claim 1.
